(19) United States
(12) Patent Application Publication
(10) Pub. No.: US 2024/0072239 A1
(43) Pub. Date: Feb. 29, 2024

(54) MULTILAYER BODY, NEGATIVE ELECTRODE COLLECTOR FOR LITHIUM ION SECONDARY BATTERIES, AND NEGATIVE ELECTRODE FOR LITHIUM ION SECONDARY BATTERIES

(71) Applicant: TDK CORPORATION, Tokyo (JP)

(72) Inventors: Yuhei HORIKAWA, Tokyo (JP); Makoto ENDO, Tokyo (JP); Takuya KAKIUCHI, Tokyo (JP); Miyuki YANAGIDA, Tokyo (JP); Yuki NAITO, Tokyo (JP); Takahiro TASHIRO, Tokyo (JP)

(73) Assignee: TDK CORPORATION, Tokyo (JP)

(21) Appl. No.: 18/268,394

(22) PCT Filed: Dec. 13, 2021
(86) PCT No.: PCT/JP2021/045877

§ 371 Date: Jun. 20, 2023

(30) Foreign Application Priority Data
Dec. 25, 2020 (JP) 2020-217392

(51) Int. Cl. H01M 4/134; H01M 4/66; H01M 10/0525

(52) U.S. Cl. CPC H01M 4/134; H01M 4/661; H01M 10/0525

(57) ABSTRACT

A laminated body contains a first metal layer containing copper and a second metal layer containing nickel and directly laminated on the first metal layer. A full width at half maximum of an X-ray diffraction peak having the maximum intensity among at least one X-ray diffraction peak derived from a nickel-containing crystal in the second metal layer is 0.3° or more and 1.2° or less.

### TECHNICAL FIELD

The present disclosure relates to a laminated body, a negative electrode current collector for a lithium ion secondary battery, and a negative electrode for a lithium ion secondary battery.

### BACKGROUND ART

A negative electrode current collector for a lithium ion secondary battery is subjected to a repetitive load (compressive stress and tensile stress) due to volume fluctuation of a negative electrode active material layer laminated on the negative electrode current collector associated with charging and discharging. Deformation of the negative electrode current collector due to this load causes deformation of a battery main body or short-circuit between electrodes. Therefore, the negative electrode current collector is required to have durability (high tensile strength) against load (particularly, tensile stress). (See Patent Literature 1 below.)

### CITATION LIST

### Patent Literature

Patent Literature 1: Japanese Unexamined Patent Publication No. 2005-197205

### SUMMARY OF INVENTION

### Technical Problem

In a case where a metal layer such as a current collector is subjected to tensile stress, cracks are formed in the metal layer due to crystal grain boundary sliding in the metal layer, and the cracks expand. As a result, the metal layer breaks. In a case where the metal layer consists of an amorphous iron-based alloy having low crystallinity, the metal layer tends to have high tensile tolerance. However, the inventors have found that a high tensile strength cannot necessarily be obtained even when the metal layer is amorphous, and that a high tensile strength can be obtained because the metal layer has a certain degree of crystallinity.

An object of one aspect of the present invention is to provide a laminated body having a high tensile strength, and a negative electrode current collector and a negative electrode for a lithium ion secondary battery including the laminated body.

### Solution to Problem

A laminated body according to one aspect of the present invention contains a first metal layer containing copper and a second metal layer containing nickel and directly laminated on the first metal layer. A full width at half maximum of an X-ray diffraction peak having the maximum intensity among at least one X-ray diffraction peak derived from a nickel-containing crystal in the second metal layer is 0.3° or more and 1.2° or less.

The second metal layer may further contain at least one element selected from the group consisting of carbon, phosphorus, and tungsten.

A negative electrode current collector for a lithium ion secondary battery according to one aspect of the present invention contains the above-described laminated body.

A negative electrode for a lithium ion secondary battery according to one aspect of the present invention contains the above-described negative electrode current collector and a negative electrode active material layer containing a negative electrode active material, in which the negative electrode active material layer is directly laminated on the second metal layer.

The negative electrode active material may contain silicon.

### Advantageous Effects of Invention

According to one aspect of the present invention, there are provided a laminated body having a high tensile strength, and a negative electrode current collector and a negative electrode for a lithium ion secondary battery including the laminated body.

### BRIEF DESCRIPTION OF DRAWINGS

FIG. 1 is a schematic perspective view of a laminated body (negative electrode current collector) according to an embodiment of the present invention and a negative electrode including the laminated body.

FIG. 2 shows an example of an X-ray diffraction pattern measured by making an X-ray be incident on a surface of a second metal layer provided in the laminated body.

FIG. 3 is an enlarged view of FIG. 2 and shows an example of X-ray diffraction peak (X-ray diffraction peak having the maximum intensity) derived from a nickel-containing crystal in the second metal layer.

### DESCRIPTION OF EMBODIMENTS

Preferred embodiments of the present invention will be described below with reference to the drawings. In the drawings, the equivalent constituent elements are designated by the same reference numerals. The present invention is not limited to the following embodiments.

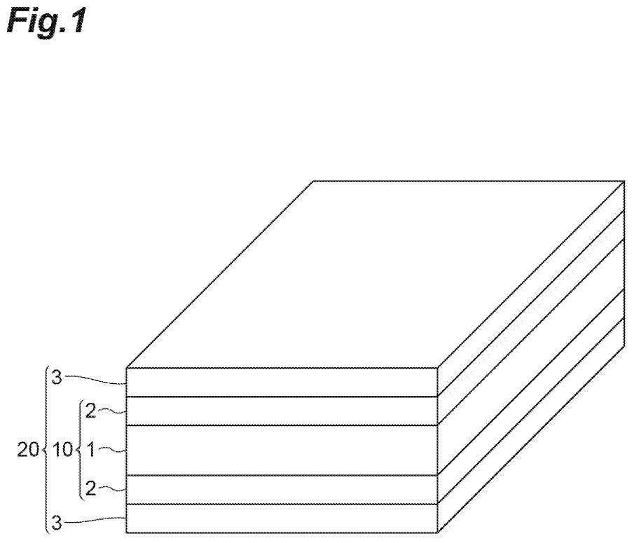

A laminated body according to the present embodiment is a negative electrode current collector for a lithium ion secondary battery. As shown in FIG. 1, a laminated body 10 according to the present embodiment has a first metal layer 1 and a second metal layers 2. The first metal layer 1 contains copper (Cu). The second metal layer 2 contains nickel (Ni). In the case of the laminated body 10 shown in FIG. 1, each of the second metal layers 2 is directly laminated on both surfaces of the first metal layer 1. However, the second metal layer 2 may be directly laminated on only one surface of the first metal layer 1.

As shown in FIG. 1, a negative electrode 20 for a lithium ion secondary battery according to the present embodiment has the laminated body 10 (negative electrode current collector) and negative electrode active material layers 3. The negative electrode active material layer 3 contains a negative electrode active material. The negative electrode active material layer 3 is directly laminated on a surface of each of the second metal layers 2.

A lithium ion secondary battery according to the present embodiment may contain the negative electrode 20, a positive electrode, a separator, and an electrolyte solution. The separator and the electrolyte solution are disposed between the negative electrode 20 and the positive electrode. The electrolyte solution permeates the separator. The positive electrode may contain a positive electrode current collector and a positive electrode active material layer laminated on the positive electrode current collector. For example, the positive electrode current collector may be an aluminum foil or a nickel foil. The positive electrode active material layer contains a positive electrode active material. For example, the positive electrode active material may be one or more compounds selected from the group consisting of lithium cobaltate (LiCoO₂), lithium nickelate (LiNiO₂), lithium manganate (LiMnO₂), lithium manganese spinel (LiMn₂O₄), LiNiₓCo_{y}Mn_{z}MₐO₂ (x+y+z+a=1, 0≤x<1, 0≤y<1, 0≤z<1, 0≤a<1, M is one or more elements selected from the group consisting of Al, Mg, Nb, Ti, Cu, Zn, and Cr), a lithium vanadium compound (LiV₂O₅), olivine-type LiMPO₄ (M is one or more elements selected from the group consisting of Co, Ni, Mn, Fe, Mg, Nb, Ti, Al, and Zr, or VO), lithium titanate (Li₄Ti₅O₁₂), LiNiₓCo_{y}Al_{z}O₂ (0.9<x+y+z<1.1), polyacetylene, polyaniline, polypyrrole, polythiophene, and polyacene. The positive electrode active material layer may further contain a conductive aid such as carbon or metal powder. The positive electrode active material layer may further contain a binder (an adhesive or a resin). The separator may be one or more membranes (film or a laminated body) formed from a porous polymer having an electrical insulation property. The electrolyte solution contains a solvent and an electrolyte (lithium salt). The solvent may be water or an organic solvent. For example, the electrolyte (lithium salt) may be one or more lithium compounds selected from the group consisting of LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB.

A full width at half maximum of an X-ray diffraction peak P_{MAX} having the maximum intensity among at least one X-ray diffraction peak derived from a Ni-containing crystal in the second metal layer 2 is 0.3° or more and 1.2° or less. When the full width at half maximum of the X-ray diffraction peak P_{MAX} is 0.3° or more and 1.2° or less, the laminated body 10 can have a high tensile strength. The tensile strength means a durability of the laminated body 10 against a tensile stress in a direction parallel to the surface of the second metal layer 2. The mechanism by which the laminated body 10 has the high tensile strength when the full width at half maximum of the X-ray diffraction peak P_{MAX} is 0.3° or more and 1.2° or less is as follows. However, the following mechanism is a hypothesis, and the technical scope of the present invention is not limited by the following mechanism.

Since the laminated body 10 has not only the first metal layer 1 but also the second metal layer 2 laminated on the first metal layer 1, the laminated body 10 can have a higher tensile strength than that of a conventional current collector consisting of only one metal layer containing Cu. However, the high tensile strength of the laminated body 10 is attributable to not only the laminated structure but also the crystallinity of the second metal layer 2.

The second metal layer 2 contains a large number of crystal grains containing Ni. With a decrease in the full width at half maximum of the X-ray diffraction peak P_{MAX}, the grain size of each crystal grain in the second metal layer 2 increases, and the crystallinity of the second metal layer 2 increases. In a case where the full width at half maximum of the X-ray diffraction peak P_{MAX} is too small, each crystal grain is too large, and a grain boundary area between a pair of adjacent crystal grains is too wide. As a result, a large crack is likely to be formed at once along the wide grain boundary due to the tensile stress to which the second metal layer 2 is subjected, the crack is likely to propagate (grow) inside the second metal layer 2, and the second metal layer 2 and the entire laminated body 10 are likely to break. However, in a case where the full width at half maximum of the X-ray diffraction peak P_{MAX} is 0.3° or more, propagation (growth) of the crack attributable to excessively large crystal grains (high crystallinity) is suppressed, and the entire laminated body 10 including the second metal layer 2 can have a high tensile strength. In other words, in a case where the full width at half maximum of the X-ray diffraction peak P_{MAX} is 0.3° or more, the crystal grains are moderately refined and the areas of the grain boundary is also moderately small, so that the propagation of the crack along the grain boundaries is suppressed.

With an increase in the full width at half maximum of the X-ray diffraction peak P_{MAX}, the grain size of each crystal grain in the second metal layer 2 decreases, and the crystallinity of the second metal layer 2 decreases. In other words, with an increase in the full width at half maximum of the X-ray diffraction peak P_{MAX}, the second metal layer 2 gradually becomes an amorphous-like state. In a case where the full width at half maximum of the X-ray diffraction peak P_{MAX} is too large, each crystal grain is too fine, so that many fine grain boundaries are formed in the second metal layer 2. As a result, cracks are likely to propagate (grow) linearly inside the second metal layer 2 along paths composed of many fine grain boundaries due to the tensile stress to which the second metal layer 2 is subjected, and the second metal layer 2 and the entire laminated body 10 are likely to break. However, in a case where the full width at half maximum of the X-ray diffraction peak P_{MAX} is 1.2° or less, cracks attributable to fine crystal grains (low crystallinity) are suppressed, and the entire laminated body 10 including the second metal layer 2 can have a high tensile strength. In other words, in a case where the full width at half maximum of the X-ray diffraction peak P_{MAX} is 1.2° or less, propagation of cracks along the grain boundaries is likely to be interrupted by moderately large crystal grains, a direction of the propagation of cracks is likely to be changed by the moderately large crystal grains, and the linear propagation of cracks is suppressed.

The tensile strength of the laminated body 10 may be, for example, 800 MPa or more and 1300 MPa or less, 890 MPa or more and 1200 MPa or less, 897 MPa or more and 1200 MPa or less, 1000 MPa or more and 1200 MPa or less, or 1006 MPa or more and 1200 MPa or less.

The full width at half maximum of the X-ray diffraction peak P_{MAX} may be 0.36° or more and 1.06° or less, 0.37° or more and 1.060 or less, or 0.390 or more and 1.060 or less for a reason that the laminated body 10 is likely to have the high tensile strength.

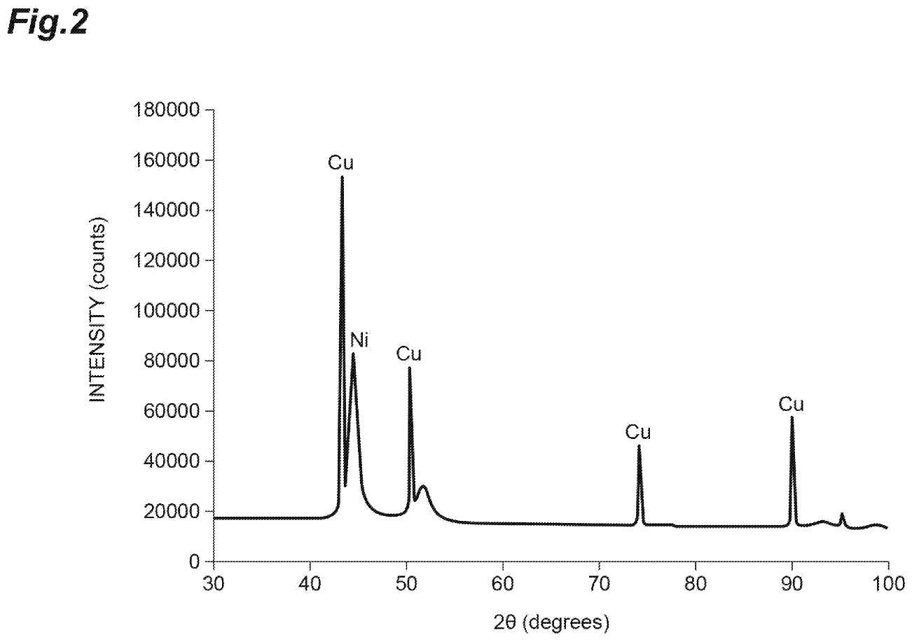

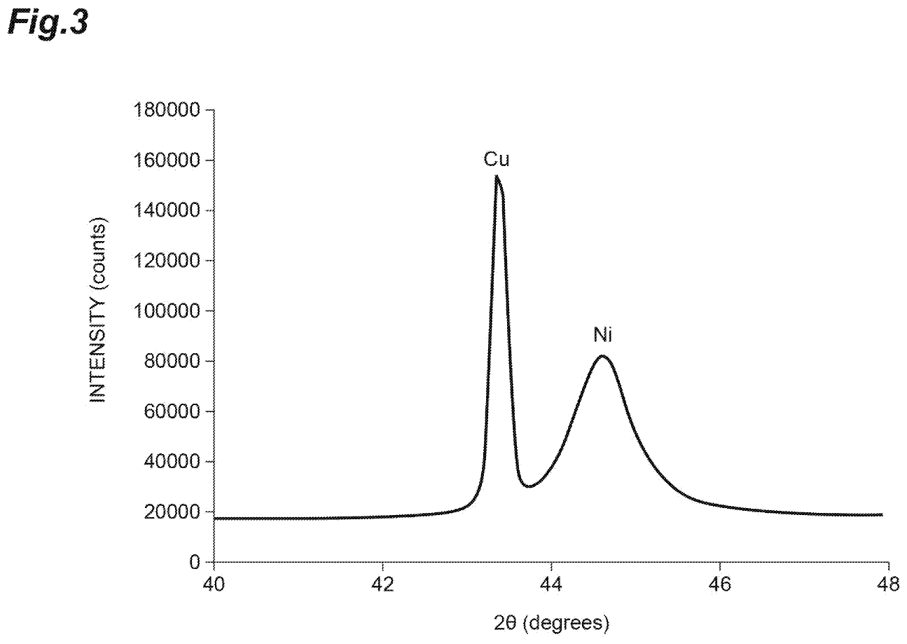

At least one X-ray diffraction peak derived from the Ni-containing crystal in the second metal layer 2 is included in an X-ray diffraction pattern measured by making an X-ray be incident on the surface of the second metal layer 2. An example of the X-ray diffraction pattern is shown in FIG. 2. FIG. 3 is an enlarged view of FIG. 2 and shows the maximum X-ray diffraction peak P_{MAX} derived from the Ni-containing crystal in the second metal layer 2. A horizontal axis of the X-ray diffraction pattern is a diffraction angle 20 (unit: degrees) of X-ray diffraction, and a vertical axis of the X-ray diffraction pattern is an intensity (unit: counts) of X-ray diffraction. The X-ray diffraction pattern may include an X-ray diffraction peak derived from another crystal in addition to the X-ray diffraction peak derived from the Ni-containing crystal. For example, as shown in FIG. 2 and FIG. 3, the X-ray diffraction pattern may include at least one X-ray diffraction peak derived from a Cu-containing crystal in the first metal layer 1 in addition to the X-ray diffraction peak derived from the Ni-containing crystal. The number of X-ray diffraction peaks derived from the Ni-containing crystal among a plurality of X-ray diffraction peaks included in the X-ray diffraction pattern may be one or more. The X-ray diffraction peak derived from the Ni-containing crystal may be distinguished from the X-ray diffraction peak derived from another crystal, based on a diffraction angle 20.

The Ni-containing crystal in the second metal layer 2 may have a face-centered cubic (fcc) structure. The X-ray diffraction peak P_{MAX} having the maximum intensity among at least one X-ray diffraction peak derived from the Ni-containing crystal in the second metal layer 2 may be an X-ray diffraction peak derived from one crystal plane selected from the group consisting of a (111) plane, a (200) plane, and a (220) plane of crystal planes of the face-centered cubic structure. The Ni-containing crystal in the second metal layer 2 may be a crystal consisting of only Ni. As long as the face-centered cubic structure of the Ni-containing crystal is maintained, the Ni-containing crystal may further contain elements other than Ni. The diffraction angle 20 of the X-ray diffraction peak P_{MAX} may vary depending on a wavelength of an incident X-ray, a composition and a lattice constant of the crystal, and the diffraction angle 20 is not particularly limited.

Ni may be a main component of the second metal layer 2. That is, in a case where the second metal layer 2 contains a plurality of kinds of elements, a content (unit: % by mass) of Ni may be largest. The content of Ni in the second metal layer 2 may be, for example, 60% by mass or more and 100% by mass or less, 60% by mass or more and less than 100% by mass, or 60% by mass or more and 99.5% by mass or less. In a case where the second metal layer 2 contains three or more kinds of elements, the content of Ni in the second metal layer 2 may be less than 50% by mass. At least a part or the whole of the second metal layer 2 may be a Ni simple substance, an alloy containing Ni, or an intermetallic compound containing Ni.

The second metal layer 2 may further contain at least one element selected from the group consisting of carbon (C), phosphorus (P), and tungsten (W). By making these elements contained in the second metal layer 2, the full width at half maximum of the X-ray diffraction peak P_{MAX} can be controlled within a range of 0.3° or more and 1.2° or less. For example, in a case where the second metal layer 2 contains C, the grain size of the Ni-containing crystal tends to decrease and the full width at half maximum of the X-ray diffraction peak P_{MAX} tends to increase. The Ni-containing crystal in the second metal layer 2 may further contain at least one element selected from the group consisting of C, P, and W. For example, the Ni-containing crystal in the second metal layer 2 may be a solid solution containing at least one element selected from the group consisting of C, P, and W.

The second metal layer 2 may be formed by an electrolytic plating method or an electroless plating method. As shown in Examples described below, according to the electrolytic plating method or the electroless plating method, the full width at half maximum of the X-ray diffraction peak P_{MAX} can be controlled within a range of 0.3° or more and 1.2° or less. For example, control factors for the full width at half maximum of the X-ray diffraction peak P_{MAX} may be a composition of a plating solution, a concentration of a raw material (compound containing Ni) in the plating solution, a temperature of the plating solution, a pH of the plating solution, a current density of the first metal layer 1, a duration time of the plating, and the like. The full width at half maximum of the X-ray diffraction peak P_{MAX} may be adjusted by a heat-treatment of the second metal layer 2 formed by the electrolytic plating method or the electroless plating method.

Cu may be a main component of the first metal layer 1. The first metal layer 1 may consist of only Cu. The first metal layer 1 may consist of an alloy containing Cu. By the first metal layer 1 containing Cu, the laminated body 10 can have a high conductivity required for a negative electrode current collector for a lithium ion secondary battery.

The negative electrode active material contained in the negative electrode active material layer 3 may be a material capable of intercalating and deintercalating lithium ions, and is not particularly limited. For example, the negative electrode active material contained in the negative electrode active material layer 3 may contain silicon (Si). The negative electrode active material containing silicon is more likely to expand and contract associated with charging and discharging of the lithium ion secondary battery compared with other negative electrode active materials. The laminated body 10 (the second metal layer 2) is repeatedly subjected to the tensile stress due to the volume fluctuation of the negative electrode active material layer 3 associated with charging and discharging. However, since the laminated body 10 according to the present embodiment has a high tensile strength, breakage of the laminated body 10 due to the volume fluctuation of the negative electrode active material layer 3 is suppressed.

The negative electrode active material containing silicon may be simple substance of silicon, an alloy containing silicon, or a compound containing silicon (oxide, silicate, or the like). For example, the alloy containing silicon may contain at least one element selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). For example, the compound containing silicon may contain at least one element selected from the group consisting of boron (B), nitrogen (N), oxygen (O), and carbon (C). For example, the negative electrode active material containing silicon may be at least one compound selected from the group consisting of SiB₄, SiB₆, Mg₂Si, Ni₂Si, TiSi₂, MoSi₂, CoSi₂, NiSi₂, CaSi₂, CrSi₂, CusSi, FeSi₂, MnSi₂, NbSi₂, TaSi₂, VSi₂, WSi₂, ZnSi₂, SiC, Si₂N₂, Si₂N₂O, SiO_{X} (0<X≤2), and LiSiO. The negative electrode active material may be fibers (such as nanowires) containing silicon or particles (such as nanoparticles) containing silicon. The negative electrode active material layer 3 may further contain a binder. The binder binds the negative electrode active materials to each other and binds the negative electrode active material layer 3 to the surface of the second metal layer 2.

A thickness T1 of the first metal layer 1 may be, for example, 1 μm or more and 8 μm or less. A thickness T2 of one second metal layer 2 may be, for example, 0.3 μm or more and 4 μm or less, or 1.1 μm or more and 2.0 μm or less. A total of the thicknesses T2 of the second metal layers 2 may be represented by T2_{TOTAL}, and T2_{TOTAL}/T1 may be 0.6 or more and 1.0 or less. For example, as shown in FIG. 1, in a case where the laminated body 10 has two second metal layers 2, T2_{TOTAL} is a total of thicknesses of the two second metal layers 2. In a case where T2_{TOTAL}/T1 is 0.6 or more, the laminated body 10 is likely to have a sufficiently high tensile strength. As T2_{TOTAL}/T1 is smaller, the raw material cost of the laminated body 10 (the second metal layer 2) is suppressed. In a case where T2_{TOTAL}/T1 is 1.0 or less, the lithium ion secondary battery containing the laminated body 10 is likely to have a sufficiently high energy density. A thickness T3 of one negative electrode active material layer 3 may be, for example, 10 μm or more and 300 μm or less. Each of the thickness T1 of the first metal layer 1, the thickness T2 of the second metal layer 2, and the thickness T3 of the negative electrode active material layer 3 may be uniform.

Dimensions of the first metal layer 1, the second metal layer 2, and the negative electrode active material layer 3 in a direction perpendicular to a direction of lamination may be approximately equal to each other. For example, a width of each of the first metal layer 1, the second metal layer 2, and the negative electrode active material layer 3 in a direction perpendicular to the direction of lamination may be several tens mm or more and several hundreds mm or less. A length of each of the first metal layer 1, the second metal layer 2, and the negative electrode active material layer 3 in the direction perpendicular to the direction of lamination may be several tens mm or more and several thousands mm or less.

The present invention is not necessarily limited to the above-described embodiments. Various modifications of the present invention are possible to the extent that the gist of the present invention is maintained, and these modified examples are also included in the present invention.

For example, the second metal layer may be formed by a vapor deposition method such as sputtering, a metalorganic chemical vapor deposition method (MOCVD), or a metalorganic physical vapor deposition method (MOPVD).

The laminated body according to the present invention may be used as a heat release material or an electromagnetic shielding material. Along with processing of the heat release material or the electromagnetic shielding material, a tensile stress acts on the heat release material or the electromagnetic shielding material. Since the laminated body according to the present invention has a high tensile strength, breakage of the heat release material or the electromagnetic shielding material along with the processing can be suppressed.

### EXAMPLES

The present invention will be explained in detail by the following Examples and Comparative Examples. The present invention is not limited by the following Examples.

[Pretreatment of First Metal Layer]

A commercially available electrolytic copper foil was used as the first metal layer. A thickness of the first metal layer was 4.5 μm. The thickness of the first metal layer was uniform. The first metal layer was immersed in an acidic degreasing solution for 1 minute to remove organic matters adhering to the surface of the first metal layer. THRU-CUP MSC-3-A manufactured by C.Uyemura & Co., Ltd. was used as the degreasing solution. After degreasing, the first metal layer was immersed in pure water for 1 minute to wash the first metal layer.

After washing the first metal layer, the first metal layer was immersed in dilute sulfuric acid for 1 minute to remove the natural oxide film present on the surface of the first metal layer. A concentration of the dilute sulfuric acid was 10% by mass. After removing the natural oxide film, the first metal layer was immersed in pure water for 1 minute to wash the first metal layer.

A laminated body of each of Examples 1 to 10 and Comparative Examples 1 to 4 was produced by the following method using the first metal layer having undergone the above pretreatment.

### Example 1

A second metal layer was formed on both surfaces of a first metal layer by the following electrolytic plating. That is, a laminated body composed of a first metal layer and a second metal layer laminated on both surfaces of the first metal layer was formed by electrolytic plating.

In electrolytic plating, the first metal layer and another electrode connected to a power supply were immersed in a plating solution, and current was applied to the second metal layer and the other electrode. The plating solution contained nickel sulfate hexahydrate, sodium tungstate dihydrate, and trisodium citrate. A content of nickel sulfate hexahydrate in the plating solution was 60 g/L. A content of sodium tungstate dihydrate in the plating solution was 100 g/L. A content of trisodium citrate in the plating solution was 145 g/L. A pH of the plating solution was adjusted to 5.0. A temperature of the plating solution was adjusted to 50° C. A current density of the first metal layer during electrolytic plating was adjusted to 5 A/dm². A duration time of electrolytic plating was 1 minute.

After the electrolytic plating, the laminated body was immersed in pure water for 1 minute to wash the laminated body. After washing the laminated body, water adhering to the laminated body was removed. After removing the water, the laminated body was subjected to heat-treatment at 110° C. for 6 hours.

A laminated body of Example 1 was produced by the above method.

### Example 2

A duration time of the electrolytic plating of Example 2 was 1.5 minutes. A laminated body of Example 2 was produced by the same method as in Example 1 except for the duration time of the electrolytic plating.

### Example 3

In the case of Example 3, the second metal layer was formed on both surfaces of the first metal layer by the following electroless plating instead of the electrolytic plating.

The first metal layer was subjected to a catalytic treatment before the electroless plating. In the catalytic treatment, the first metal layer was immersed in a catalytic treatment solution for 1 minute to deposit a catalyst (palladium sulfate) on the surface of the first metal layer. A temperature of the catalytic treatment solution was adjusted to 40° C. ACCEMULTA MNK-4-M manufactured by C.Uyemura & Co., Ltd. was used as the catalytic treatment solution.

In the electroless plating, the first metal layer subjected to the catalytic treatment was immersed in an electroless nickel plating solution for 1 minute. The electroless nickel plating solution contained sodium hypophosphite as a reducing agent. A temperature of the electroless nickel plating solution was adjusted to 90° C. A duration time of the electroless plating was 7 minutes. NIMUDEN KLP manufactured by C.Uyemura & Co., Ltd. was used as the electroless nickel plating solution.

A laminated body of Example 3 was produced by the above method.

### Example 4

A duration time of the electroless plating of Example 4 was 10 minutes. A laminated body of Example 4 was produced by the same method as in Example 3 except for the duration time of the electroless plating.

### Example 5

An electrolytic plating of Example 5 was carried out using a plating solution having a different composition from the plating solution of Example 1. The plating solution of Example 5 contained nickel sulfate hexahydrate, nickel chloride hexahydrate, boric acid, and sodium saccharin. A content of nickel sulfate hexahydrate in the plating solution of Example 5 was 240 g/L. A content of nickel chloride hexahydrate in the plating solution of Example 5 was 45 g/L. A content of boric acid in the plating solution of Example 5 was 30 g/L. A content of sodium saccharin in the plating solution of Example 5 was 2 g/L. A pH of the plating solution of Example 5 was adjusted to 4.2. A temperature of the plating solution of Example 5 was adjusted to 40° C. A duration time of the electrolytic plating of Example 5 was 1.5 minutes.

A laminated body of Example 5 was produced by the same method as in Example 1 except for the above matters.

### Example 6

A duration time of electrolytic plating of Example 6 was 2 minutes. A laminated body of Example 6 was produced by the same method as in Example 5 except for the duration time of the electrolytic plating.

### Example 7

A content of sodium tungstate dihydrate in the plating solution of Example 7 was 30 g/L. A content of trisodium citrate in the plating solution of Example 7 was 80 g/L. A pH of the plating solution of Example 7 was adjusted to 7.0. A duration time of electrolytic plating of Example 7 was 4 minutes.

A laminated body of Example 7 was produced by the same method as in Example 1 except for the above matters.

### Example 8

A content of nickel sulfate hexahydrate in the plating solution of Example 8 was 70 g/L. A content of sodium tungstate dihydrate in the plating solution of Example 8 was 15 g/L. A content of trisodium citrate in the plating solution of Example 8 was 80 g/L. A pH of the plating solution of Example 8 was adjusted to 7.0. A duration time of electrolytic plating of Example 8 was 3 minutes.

A laminated body of Example 8 was produced by the same method as in Example 1 except for the above matters.

### Example 9

A content of nickel sulfate hexahydrate in the plating solution of Example 9 was 75 g/L. A content of sodium tungstate dihydrate in the plating solution of Example 9 was 8 g/L. A content of trisodium citrate in the plating solution of Example 9 was 80 g/L. A pH of the plating solution of Example 9 was adjusted to 7.0. A duration time of electrolytic plating of Example 9 was 3 minutes.

A laminated body of Example 9 was produced by the same method as in Example 1 except for the above matters.

### Example 10

A content of nickel sulfate hexahydrate in the plating solution of Example 10 was 80 g/L. A content of sodium tungstate dihydrate in the plating solution of Example 10 was 4 g/L. A content of trisodium citrate in the plating solution of Example 10 was 80 g/L. A pH of the plating solution of Example 10 was adjusted to 7.0. A duration time of the electrolytic plating of Example 10 was 3 minutes.

A laminated body of Example 10 was produced by the same method as in Example 1 except for the above matters.

### Comparative Example 1

A plating solution of Comparative Example 1 did not contain sodium saccharin. A laminated body of Comparative Example 1 was produced by the same method as in Example 5 except that the plating solution did not contain sodium saccharin.

### Comparative Example 2

A duration time of the electrolytic plating of Comparative Example 2 was 2 minutes. A laminated body of Comparative Example 2 was produced by the same method as in Comparative Example 1 except for the duration time of the electrolytic plating.

### Comparative Example 3

An electroless plating of Comparative Example 3 was carried out using an electroless nickel plating solution having a different composition from the electroless nickel plating solution of Example 3. A content of sodium hypophosphite in the electroless nickel plating solution of Comparative Example 3 was larger than the content of sodium hypophosphite in the electroless nickel plating solution of Example 3. ICP NICORON SOF manufactured by OKUNO Chemical Industries Co., Ltd. was used as the electroless nickel plating solution of Comparative Example 3. A temperature of the electroless nickel plating solution of Comparative Example 3 was adjusted to 85° C.

A laminated body of Comparative Example 3 was produced by the same method as in Example 3 except for the above matters.

### Comparative Example 4

A duration time of the electroless plating of Comparative Example 4 was 10 minutes. A laminated body of Comparative Example 4 was produced by the same method as in Comparative Example 3 except for the duration time of the electroless plating.

[Analysis of Laminated Body]

The laminated body of each of Examples 1 to 10 and Comparative Examples 1 to 4 was analyzed by the following methods.

The laminated body was cut in a direction of lamination (a direction perpendicular to the surface of the second metal layer). A cross-section of the laminated body was observed by a scanning electron microscope (SEM).

A composition of the second metal layer exposed in the cross-section of the laminated body was analyzed by an energy dispersive X-ray spectroscopy (EDS). It was confirmed that the second metal layer of each of Examples 1 to 10 and Comparative Examples 1 to 4 contained constituent elements shown in Table 1 below. A content of Ni in the second metal layer of each of Examples 1 to 10 and Comparative Examples 1 to 4 is shown in Table 1 below.

In all cases of Examples 1 to 10 and Comparative Examples 1 to 4, a thickness of each second metal layer laminated on both surfaces of the first metal layer was uniform. The thickness of the second metal layer was measured in the cross-section of the laminated body. The thickness T2 of the second metal layer is shown in Table 1 below. A total T2_{TOTAL} of the thicknesses T2 of two second metal layers 2 is also shown in Table 1 below.

An X-ray diffraction pattern was measured by making an X-ray be incident on the surface of the second metal layer provided in the laminated body. CuKα ray was used as the incident X-ray.

In all cases of Examples 1 to 10 and Comparative Examples 1 and 2, at least one X-ray diffraction peak derived from a Ni crystal in the second metal layer was included in the X-ray diffraction pattern. On the other hand, in the cases of Comparative Examples 3 and 4, no distinct X-ray diffraction peak derived from the Ni crystal in the second metal layer was detected. Therefore, it was speculated that the second metal layer of each of Comparative Examples 3 and 4 is amorphous.

In the cases of Examples 1 to 10 and Comparative Examples 1 and 2, a full width at half maximum of the X-ray diffraction peak P_{MAX} having the maximum intensity among at least one X-ray diffraction peak derived from the Ni crystal in the second metal layer is shown in Table 1 below. In all cases of Examples 1 to 10 and Comparative Examples 1 and 2, the X-ray diffraction peak P_{MAX} having the maximum intensity was an X-ray diffraction peak derived from a (111) plane of the Ni crystal (face-centered cubic structure).

The X-ray diffraction pattern of Example 4 is shown in FIG. 2. The X-ray diffraction peak P_{MAX} of Example 4 is shown in FIG. 3.

[Tensile Test]

A tensile strength of the laminated body of each of Examples 1 to 10 and Comparative Examples 1 to 4 was measured by the following tensile test using a load tester. FTN1-13A manufactured by Aikoh Engineering Co., Ltd. was used as the load tester.

A test piece was produced by punching the laminated body in a direction of lamination. A shape of the test piece was a dumbbell shape. A tension was applied to the test piece and the tension was gradually increased until the test piece broke. A value obtained by dividing the maximum tension (unit: N) immediately before the test piece breaks by a cross-sectional area (unit: m²) of the test piece is the tensile strength (unit: MPa). The tensile strength of each of Examples 1 to 10 and Comparative Examples 1 to 4 is shown in Table 1 below.

TABLE 1

| | | | | | Full width | |
|---|---|---|---|---|---|---|
| | Constituent | Content | | | at half | Tensile |
| | element | of Ni | T2 | T2_{TOTAL} | maximum | strength |
| Unit | — | mass % | μm | μm | degrees | MPa |
| Example 1 | Ni, W | 60 | 1.1 | 2.2 | 1.04 | 1006 |
| Example 2 | Ni, W | 61 | 1.5 | 3.0 | 1.06 | 1200 |
| Example 3 | Ni, P | 99 | 1.6 | 3.2 | 0.78 | 1026 |
| Example 4 | Ni, P | 99 | 2.0 | 4.0 | 0.75 | 1133 |
| Example 5 | Ni, C | 99.5 | 1.4 | 2.8 | 0.40 | 898 |
| Example 6 | Ni, C | 99.5 | 1.9 | 3.8 | 0.39 | 1012 |
| Example 7 | Ni, W | 79 | 1.5 | 3.0 | 0.37 | 1142 |
| Example 8 | Ni, W | 89 | 1.5 | 3.0 | 0.36 | 1009 |
| Example 9 | Ni, W | 94 | 1.5 | 3.0 | 0.30 | 952 |
| Example 10 | Ni, W | 97 | 1.5 | 3.0 | 0.30 | 897 |
| Comparative | Ni | 100 | 1.5 | 3.0 | 0.25 | 651 |
| Example 1 | | | | | | |
| Comparative | Ni | 100 | 2.0 | 4.0 | 0.27 | 723 |
| Example 2 | | | | | | |
| Comparative | Ni, P | 88 | 1.5 | 3.0 | — | 549 |
| Example 3 | | | | | | |
| Comparative | Ni, P | 88 | 2.1 | 4.2 | — | 755 |
| Example 4 | | | | | | |

### INDUSTRIAL APPLICABILITY

For example, the laminated body according to one aspect of the present invention may be used for a negative electrode current collector of a lithium ion secondary battery.

### REFERENCE SIGNS LIST

1: first metal layer, 2: second metal layer, 3: negative electrode active material layer, 10: laminated body (current collector), 20: negative electrode.

1. A laminated body comprising:
a first metal layer containing copper; and
a second metal layer containing nickel and directly laminated on the first metal layer, wherein
a full width at half maximum of an X-ray diffraction peak having the maximum intensity among at least one X-ray diffraction peak derived from a nickel-containing crystal in the second metal layer is 0.3° or more and 1.2° or less.

2. The laminated body according to claim 1, wherein the second metal layer further contains at least one element selected from the group consisting of carbon, phosphorus, and tungsten.

3. A negative electrode current collector for a lithium ion secondary battery, comprising the laminated body according to claim 1.

4. A negative electrode for a lithium ion secondary battery, comprising:
the negative electrode current collector according to claim 3; and
a negative electrode active material layer containing a negative electrode active material, wherein
the negative electrode active material layer is directly laminated on the second metal layer.

5. The negative electrode according to claim 4, wherein the negative electrode active material contains silicon.
